(19) United States
(12) Patent Application Publication
(10) Pub. No.: US 2010/0163114 A1
(43) Pub. Date: Jul. 1, 2010

(54) MICRO MIXER

(75) Inventors: Hidekazu Yoshizawa, Okayama-shi (JP); Eiji Kamio, Nakago-cho (JP)

Correspondence Address: OLIFF & BERRIDGE, PLC, P.O. BOX 320850, ALEXANDRIA, VA, 22320-4850, US

(73) Assignee: NATIONAL UNIVERSITY CORPORATION OKAYAMA UNIVERSITY, OKAYAMA-SHI (JP)

(21) Appl. No.: 12/450,107

(22) PCT Filed: Mar. 14, 2008
(86) PCT No.: PCT/JP2008/054821

§ 371 Date: Feb. 26, 2010

(30) Foreign Application Priority Data
Mar. 16, 2007 (JP) 2007-068745
Mar. 16, 2007 (JP) 2007-068751

(51) Int. Cl. G05D 11/00

(52) U.S. Cl. 137/87.01

(57) ABSTRACT

A micro mixer including a first tubular member for guiding a first fluid to be directed in a first direction; a second tubular member having a discharge portion in the downstream portion of said first tubular member for guiding a second fluid to be directed in a direction opposite to said first direction, said discharge portion having a flow passage space narrower than the flow passage space of the downstream portion of the first tubular member; a first annular space defined by the downstream portion of the first tubular member and the discharge portion of the second tubular member for guiding a mixed fluid caused by colliding the first fluid flowing in the first tubular member with the second fluid flowing in the second tubular member in a counter-flow manner to be directed in the same direction as said first direction and further for increasing the pressure of said mixed fluid; a mixing-promoting space communicating with said first annular space for lowering the pressure of the mixed fluid discharged from said first annular space to promote mixing of the mixed fluid with the aid of vortexes caused in connection with the pressure drop of the mixed fluid; and a third tubular member for guiding the mixed fluid in said mixing-promoting space into a predetermined collecting unit.

### TECHNICAL FIELD

This invention relates to a novel micro mixer capable of mixing and stirring small quantities of two kinds of fluids by means of micro-fluidic elements having a microstructure, represented by micro-reactors which are so-called the μ-TAS (abbreviated expression of Micro Total Analysis System) in Europe, and Lab-on-A-chip in the United States of America.

### BACKGROUND ART

As structures of micro mixers of the prior art, known are the micro mixer using a substrate formed with Y-shaped fine flow passages as disclosed, for example, in Patent Document 1, and the micro mixer using a substrate formed with T-shaped fine flow passages as disclosed in Patent Document 2.

### Patent Document 1: Japanese Patent Application Laid Open Publication No. 2006-205,080

### Patent Document 2: Japanese Patent Application Laid Open Publication No. 2006-7,063

In these micro mixers formed with Y-shaped or T-shaped fine flow passages, the flows are laminar flows. Therefore, solutions supplied from two supply ports become two layers in the fine flow passages. Since mixing and stirring of these flows of two layers mainly depends on diffusion of the fluids, it would be difficult to perform complete mixing in a short time so that it should take a certain length of time for mixing and stirring the solutions. This problem remains to be solved.

In order to enlarge an interface area between the two liquids for the purpose of shortening the mixing time, it may be contemplated that for example, the flow of two layers is divided on a plane surface into a large number of laminar flows, thereby improving the mixing and stirring efficiencies. With this approach, however, complicated multiple flow passages must be formed by a high-precision processing technology for dividing the flows into a great number of flows so that its working cost goes up unfavorably. Even if the multiple flow passages are somehow obtained, the fluids remain to be laminar flows because they are two-dimensionally formed passages so that mixing efficiency is not fully satisfactory since mixing and stirring mainly depends on the diffusion of the fluids as described above. In addition, in order to form multiple flow passages on a plane surface, to some extent a large area of a substrate is required so that this approach could not be used for an application to make the entire micro mixer more smaller.

As micro mixers of the prior art other than those described above, a wide variety of micro mixers have been reported such as a mixer using porous filters, a mixer employing multiple laminar flows, a mixer performing mixing by chaotic mixing utilizing spiral flows of fluids, a mixer utilizing false eddy flows caused by collide fluid flows with flow passage walls, micro mixers utilizing ultrasonic waves, electric fields, magnetic fields or micro stirrers (for example, disclosed in Patent Document 3), and the like. However, all of these micro mixers have disadvantages that their flow passage patterns or structural configurations are complicated so that they are expensive and not suitable for massive production.

### Patent Document 3: Japanese Patent Application Laid Open Publication No. 2006-320,877

### DISCLOSURE OF THE INVENTION

### Problems to be Solved by the Invention

In view of the problems described above, an object of the invention is to provide with a micro mixer being a smaller size and a comparatively simple construction and effectively increasing its mixing efficiency.

### Solution for the Problems

The essential features of the invention for achieving the above object are as follows.

(1) A micro mixer characterized in comprising: a first guide flow passage for guiding a first fluid to be directed in a first direction; a second guide flow passage having a discharge portion in the downstream portion of said first guide flow passage for guiding a second fluid to be directed in a direction opposite to said first direction, said discharge portion having a flow passage space narrower than the flow passage space of the downstream portion of said first guide flow passage; a third guide flow passage defined by the downstream portion of said first guide flow passage and the discharge portion of said second guide flow passage for guiding a mixed fluid caused by colliding the first fluid flowing in the first guide flow passage with the second fluid flowing in the second guide flow passage in a counter-flow manner to be directed in the same direction as said first direction and for increasing the pressure of said mixed fluid; a mixing-promoting space communicating with said third guide flow passage for lowering the pressure of the mixed fluid discharged from said third guide flow passage to promote the mixing of the mixed fluid with the aid of vortexes caused in connection with the pressure drop of the mixed fluid; and a fourth guide flow passage for guiding the mixed fluid in said mixing-promoting space into a predetermined collecting means (first invention).

(2) The micro mixer as described in the above (1), wherein the first to fourth guide flow passages are formed by connecting at least three tubular members, wherein the first guide flow passage is formed by the first tubular member, and the second guide flow passage is formed by the second tubular member having a tubular leading end inserted in the downstream portion of said first tubular member, wherein the third guide flow passage is a first annular space defined by the downstream portion of said first tubular member and the tubular leading end of said second tubular member, and the mixing-promoting space is a pressure-relieving space formed in a block-shaped member positioned between the inlet and the outlet of the second guide flow passage, and wherein the fourth guide flow passage is formed by the third tubular member.

(3) The micro mixer as described in the above (1), comprising a laminated body of at least two plate-shaped members, wherein the first guide flow passage is a first defined groove defined and formed by a bottom wall and first groove walls on the first plate-shaped member and is substantially two-dimensionally rectangular, and the second guide flow passage is a second defined groove having a leading groove defined and formed by second groove walls in the downstream portion of said first defined groove on said first plate-shaped member, wherein the third guide flow passage is a third defined grooves defined by the downstream portion of said first defined groove and the leading groove of said second defined groove, and the mixing-promoting space is a pressure-relieving space formed in the second plate-shaped member overlapped together with said first plate-shaped member at a location enabling the mixed fluid discharged from the third defined groove of said first plate-shaped member to flow into the mixing-promoting space, and wherein the fourth guide flow passage is formed by a guide member for guiding the mixed fluid flowing out of said second plate-shaped member into predetermined collecting means.

(4) A micro mixer characterized in comprising a first guide flow passage having a first guide portion for guiding a first fluid to be directed in a first direction and a second guide portion connected to said first guide portion with an enlarged size of the second guide portion; a second guide flow passage having in the second guide portion of said first guide flow passage a discharge portion for guiding a second fluid to be directed in a direction opposite to said first direction, said discharge portion having a flow passage space narrower than the flow passage space of the second guide portion of the first guide flow passage; a third guide flow passage defined by the second guide portion of the first guide flow passage and the discharge portion of the second guide flow passage for guiding a mixed fluid caused by colliding the first fluid flowing in the first guide flow passage with the second fluid flowing in the second guide flow passage in a counter-flow manner to be directed in the same direction as said first direction and further for increasing the pressure of said mixed fluid; a mixing-promoting space communicating with said third guide flow passage for lowering the fluid pressure of the mixed fluid discharged from said third guide flow passage to promote the mixing of the mixed fluid with the aid of vortexes caused in connection with the pressure drop of the mixed fluid; and a fourth guide flow passage for guiding the mixed fluid in said mixing-promoting space into predetermined collecting means (second invention).

(5) The micro mixer as described in the above (4), wherein the first to fourth guide flow passages are formed by connecting at least three tubular members, and the first guide flow passage is formed by the first tubular member constructed by connecting a thin tube as the first guide portion and a thick tube as the second guide portion, wherein the second guide flow passage is formed by the second tubular member having a tubular leading end inserted in the thick tube of said first tubular member, and the third guide flow passage is a first annular space defined by the thick tube of said first tubular member and the tubular leading end of said second tubular member, and wherein the mixing-promoting space is a pressure-relieving space formed in a block-shaped member positioned between the inlet and the outlet of the second guide flow passage, and the fourth guide flow passage is formed by a third tubular member.

(6) The micro mixer as described in the above (4), comprising a laminated body of at least two plate-shaped members, wherein the first guide flow passage is a first defined groove defined and formed by a bottom wall and first groove walls on the first plate-shaped member and constructed by connecting a thin groove portion as a first guide portion and a thick groove portion as a second guide portion, and the second guide flow passage is a second defined groove having a leading groove defined and formed by second groove walls in the thick groove portion of said first defined groove on said first plate-shaped member, wherein the third guide flow passage is a third defined grooves defined by the thick groove portion of said first defined groove and the leading groove of said second defined groove, and the mixing-promoting space is a pressure-relieving space formed in the second plate-shaped member overlapped together with said first plate-shaped member at a location enabling the mixed fluid discharged from the third defined grooves of said first plate-shaped member to flow into the mixing-promoting space, and wherein the fourth guide flow passage is formed by a guide member for guiding the mixed fluid flowing out of said second plate-shaped member into predetermined collection means.

### EFFECT OF THE INVENTION

According to the invention it becomes possible to provide a micro mixer enabling its mixing efficiency to be effectively increased even if it has a small size and is comparatively simple in construction. Particularly, according to the invention it is possible to increase the mixing efficiency of a mixed fluid caused by colliding a first fluid flowing in the first guide flow passage with a second fluid flowing in the second guide flow passage in a counter-flow manner. According to the invention, moreover, the mixed fluid caused by collision is guided in the discharge port of discharge portion of the second guide flow passage to be directed in the same direction as the first direction of the first fluid so as to produce vortexes so that it is possible to further increase the mixing efficiency with the aid of the vortexes. According to the invention, the pressure of the mixed fluid is increased by narrowing the flow passage in the third guide flow passage so that diffusion distances of molecules are shortened as much as possible, and therefore it is possible to further increase the mixing efficiency with the aid of the shortened diffusion distances of molecules. According to the invention, furthermore, the mixed fluid discharged from the third guide flow passage is caused to flow into the mixing-promoting space so that the pressure of the mixed fluid is lowered to produce vortexes, and therefore it is possible to promote the mixing of the mixed fluid with the aid of the vortexes formed by pressure drop of the mixed fluid. As a result of these procedures according to the invention, the complete mixing can be readily accomplished even if first and second fluids are difficult to form a mixed fluid in a complete mixed state, and even with low flow rates (low velocities) of fluids.

### BRIEF DESCRIPTION OF THE DRAWINGS

FIG. 1 is a front elevation of the micro mixer of the first embodiment according to the invention (first invention);

FIG. 2 is an exploded view of the micro mixer shown in FIG. 1;

FIG. 3 is a schematic view for illustrating a mixed fluid caused by colliding a first fluid flow in a first tubular member with a second fluid flow in a second tubular member in counter-flow manner in the micro mixer shown in FIG. 1;

FIG. 4 is an exploded perspective view of the micro mixer of the second embodiment according to the invention (first invention);

FIG. 5 is a schematic view for illustrating a mixed fluid caused by colliding a first fluid flow in a first defined groove with a second fluid flow in a second defined groove in counter-flow manner in the micro mixer shown in FIG. 4;

FIG. 6 is a schematic view for illustrating a mixed fluid caused by colliding a first fluid flow in the first tubular member with a second fluid flow in the second tubular member in a counter-flow manner in the micro mixers of Comparative Examples 1 and 2;

FIG. 7 is a graph showing evaluation results from measurements of absorbance at the wavelength of 353 nm versus flow rates of the mixed fluids discharged from the guide members in the Example 1 and Comparative Examples 1 and 2;

FIG. 8 is a front elevation of the micro mixer of the third embodiment according to the invention (second invention);

FIG. 9 is an exploded view of the micro mixer shown in FIG. 8;

FIG. 10 is a schematic view for illustrating a mixed fluid caused by colliding a first fluid flow in a first tubular member with a second fluid flow in a second tubular member in a counter-flow manner in the micro mixer shown in FIG. 8;

FIG. 11 is an exploded perspective view of the micro mixer of the fourth embodiment according to the invention (second invention);

FIG. 12 is a schematic view for illustrating a mixed fluid caused by colliding a first fluid flow in the first defined groove with a second fluid flow in the second defined groove in a counter-manner in the micro mixer shown in FIG. 4; and

FIG. 13 is a graph showing evaluation results from measurements of absorbance at the wavelength of 353 nm versus flow rates of the mixed fluids discharged from the third tubular members in the Example 2 and Comparative Examples 1 and 2.

### DESCRIPTION OF THE REFERENCE NUMERALS

1A, 1B, 101A, 101B Micro mixers
2 First tubular member
3 Second tubular member
4 First annular space
5 Mixing-promoting space
6 Third tubular member
7 First fluid
8 Second fluid
10 Outer tube
11 Inner tube
12 Connection portion
13 Inlet of second tubular member
14 Outlet of second tubular member
15 Block-shaped member
16, 17, 18 Sealing materials
19, 20, 21 Nuts
22, 23, 24 Threaded portions of block-shaped members
102 First defined groove
103 Second defined groove
104 Third defined groove
105 Mixing-promoting space
106 Guide member
107 First plate-shaped member
108 Bottom wall
109 First groove wall
110 Second groove wall
111 Second plate-shaped member
112, 113 Plate-shaped members

### BEST MODE FOR CARRYING OUT THE INVENTION

The micro mixer according to the invention (first invention) comprises a first guide flow passage, which is straight, for guiding a first fluid to be directed in a first direction; a second guide flow passage having a discharge portion in the downstream portion of said first guide flow passage for guiding a second fluid to be directed in a direction opposite to said first direction, said discharge portion having a flow passage space narrower than the flow passage space of the downstream portion of said first guide flow passage, preferably said discharge portion being positioned at the center of the first guide flow passage, and the second guide flow passage being straight and provided concentrically to the first guide flow passage; a third guide flow passage defined by the downstream portion of the first guide flow passage and the discharge portion of the second guide flow passage for guiding a mixed fluid obtained by causing the first fluid flowing in the first guide flow passage and the second fluid flowing in the second guide flow passage to collide against each other to be directed in the same direction as said first direction and for raising the pressure of said mixed fluid; a mixing-promoting space communicating with said third guide flow passage for lowering the fluid pressure of the mixed fluid discharged from said third flow passage to promote the mixing of the mixed fluid with the aid of vortexes produced in connection with the pressure drop of the mixed fluid; and a fourth guide flow passage for guiding the mixed fluid in said mixing-promoting space into predetermined collecting means.

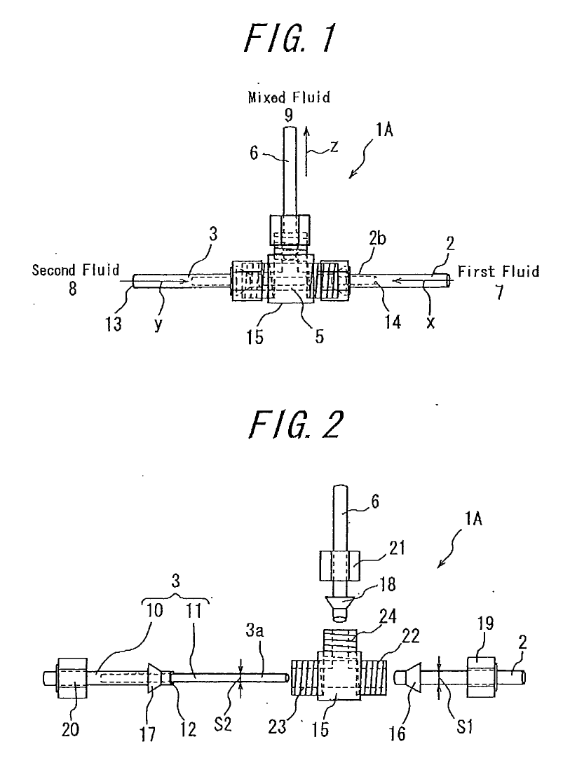

The first embodiment according to the invention (first invention) will be now described with reference to the drawings hereinafter. FIGS. 1 and 2 illustrate main components of the micro mixer according to the first embodiment of the first invention in a front elevation and an exploded view, respectively.

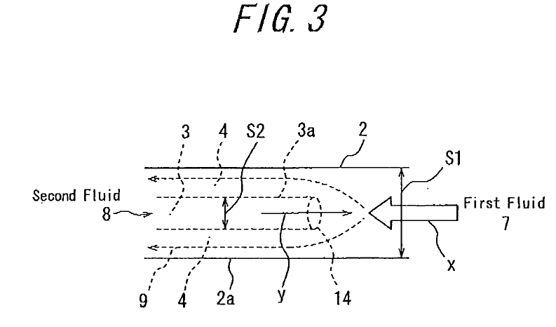

The micro mixer 1A of the first embodiment shown in FIGS. 1 and 2 mainly comprises a first tubular member 2 as a first guide flow passage, a second tubular member 3 as a second guide flow passage, a first annular space 4 (FIG. 3) as a third guide flow passage, a mixing-promoting space 5, and a third tubular member 6 as a fourth guide flow passage. The micro mixer 1A is formed by connecting at least three tubular members, namely the three tubular members 2, 3 and 6 preferably in a T-shaped form in FIG. 1.

The first tubular member 2 is preferably straight to guide a first fluid 7 so as to be directed in a first direction x.

The second tubular member 3 is preferably straight to guide a second fluid 8 into the downstream portion 2b of the first tubular member 2 in a direction y opposite to the first direction x, preferably in a direction of an angle of 150° to 180° relative to the first direction x, and most preferably in a direction of an angle of 180° relative to the first direction, that is, in the direction y opposite to the first direction x as shown in FIG. 1. The second tubular member 3 has a tubular leading end 3a as a discharge portion (FIG. 3), which has a flow passage space S2 narrower than a flow passage space S1 of the downstream portion 2b of the first tubular member 2. In FIG. 2, the second tubular member 3 is shown as a double tube structure which consists of an outer tube 10 having the same size as the first tubular member 2 and an inner tube 11 whose one end is inserted in the outer tube 10 and the other end is inserted in the first tubular member 2, and the connection portion 12 of the outer tube 10 and the inner tube 11 is sealed in a watertight manner. However, the second tubular member 3 may be constructed by one tube having the same diameter over its full length.

As shown in FIG. 3, a first annular space 4 is defined by the downstream portion 2b of the first tubular member 2 and the tubular leading end 3a of the second tubular member 3 so that the first fluid 7 flowing in the first tubular member 2 and the second fluid 8 flowing in the second tubular member 3 collide with each other in a counter-flow manner to obtain a mixed fluid 9 which is guided to be directed in the same direction as said first direction x, preferably in a direction of an angle of 0° to 30° relative to the first direction x, most preferably in a direction of an angle of 0° relative to the first direction x as shown in FIG. 1, and at the same time the pressure of the mixed fluid 9 is increased. As means for increasing the pressure of the mixed fluid 9 in the first annular space 4, for example, FIGS. 1 and 3 illustrate that the cross-sectional area of the flow passage of the first annular space 4 is narrowed in such a manner that the outer diameter of the tubular leading end 3a of the second tubular member 3 is enlarged as close to the inner diameter of the first tubular member 2 as possible. The pressure of the mixed fluid 9 may be increased by increasing the flow rate of the first fluid 7 or the second fluid 8. In order to increase the pressure of the mixed fluid 9, various configurations may be considered.

As shown in FIG. 1, a mixing-promoting space 5 is a pressure-relieving space formed in a block-shaped member 15 positioned between an inlet 13 and an outlet 14 of the second tubular member 3, and is communicated with the first annular space 4. The mixing-promoting space 5 is provided for lowering the pressure of the mixed fluid 9 discharged from the first annular space 4 so as to promote mixing of the mixed fluid 9 by vortexes caused in connection with the pressure drop of the mixed fluid 9.

A third tubular member 6 is provided for guiding the mixed fluid 9 in the mixing-promoting space 5 to a predetermined collecting means (not shown). In FIG. 1, the third tubular member 6 is mounted on a block-shaped member 15 for guiding the mixed fluid 9 flowing the annular space 4 in a direction z deflected by an angle of 90° relative to the direction x.

FIG. 3 is a schematic view for illustrating the flow of the mixed fluid 9 caused by collision of the first fluid 7 flowing in the first tubular member 2 with the second fluid 8 flowing in the second tubular member 3.

In the micro mixer of the first embodiment according to the invention (first invention), the first fluid 7 and the second fluid 8 are supplied in a counter-flow manner at a position of the outlet 14 of the second tubular member 3 discharging the second fluid 8 or at an immediately downstream position thereof so that the two fluids are mixed with each other by collision to obtain the mixed fluid 9 as shown in FIG. 3. However, in the case that the mixed fluid 9 is difficult to form a completely mixed state such as, for example, a mixed fluid consisting of water as a first fluid and a 10% solution of polyacrylic acid as a second fluid, a completely mixed state could not be obtained by mixing the two fluids of low flow rates (or low velocities), for example, 0.1 ml/min or less by using a micro mixer of the prior art.

Then, said mixed fluid 9 is discharged into the mixing-promoting space 5 after the fluid pressure of the mixed fluid 9 has been increased in the first annular space 4 defined by the downstream portion 2b of the first tubular member 2 and the tubular leading end 3a of the second tubular member 3. At this time, the direction of the mixed fluid 9 flowing in the first annular space 4 is the same as the flowing direction (direction x) of the first fluid 7, but is opposite to the flowing direction (direction y) of the second fluid 8.

And, according to the invention, the mixing and agitating or stirring of the mixed fluid 9 discharged from the first annular space 4 into the mixing-promoting space 5 is further promoted by vortexes produced when the fluid pressure of the mixed fluid 9 pressurized in the first annular space 4 is relieved in the mixing-promoting space 5, as a result of which according to the invention the fluids mixing efficiency can be effectively enhanced even in such a comparatively simple arrangement.

According to the first invention, moreover, the ratio among cross-sectional areas of the first tubular member 2, the second tubular member 3, and the first annular space 4 should preferably be set to 5-10:1:1-3 because such a ratio contributes to the effects for increasing the kinetic energy of the two fluids associated with the mixing caused by the collision, for decreasing diffusion distances of molecules associated with the mixing caused by contracted flows, and for effectively forming the vortexes associated with the mixing caused by the pressure rise and the pressure relieve (pressure drop) of the mixed fluid.

The second fluid 8 discharged from the second tubular member 3 is preferably larger in fluid flux than the first fluid 7 flowing in the first tubular member 2. For example, in the case that the first fluid 7 is 2% solution of sulfuric acid and the second fluid 8 is 10% solution of sodium hydroxide, it is preferred that the difference in fluid flux between the second fluid 8 and the first fluid 7 is 20 mm/s or more.

Moreover, the fluid pressure P1 of the mixed fluid 9 flowing in the first annular space 4 is preferably 0.2 to 5 MPa, while the fluid pressure P2 of the mixed fluid 9 flowing in the mixing-promoting space 5 is preferably 0.1 to 1 MPa. The pressure difference (P1−P2) is preferably 0.1 to 5 MPa, more preferably 0.5 to 1 MPa. Further, a mixing ratio of the first and second fluids may be adjusted by, for example, suitably setting flow rates of pumps for supplying the first and second fluids, respectively.

In order to prevent said fluids from flowing in reverse directions, furthermore, the first and second tubular members 2 and 3 may be provided with check valves (not shown), if desired.

In the micro mixer of the first embodiment, further in FIG. 2, the first, second, and third tubular members 2, 3 and 6 are provided with sealing members 16, 17 and 18 for keeping the water-tightness, respectively, and connection portions of nuts 19, 20 and 21 provided on the first, second, and third tubular members 2, 3 and 6 are screw-connected to threaded portions 22, 23 and 24 provided on the block-shaped member 15 forming the first annular space, respectively. However, the invention is not to be limited to such an embodiment. The material for said sealing members 16, 17 and 18 is not limited to a particular material insofar as water-tightness is ensured. The materials for said sealing members may be, for example, metals such as aluminum, alloys such as stainless steel or nickel based alloy, plastic resins such as Teflon (registered trade name), and the like.

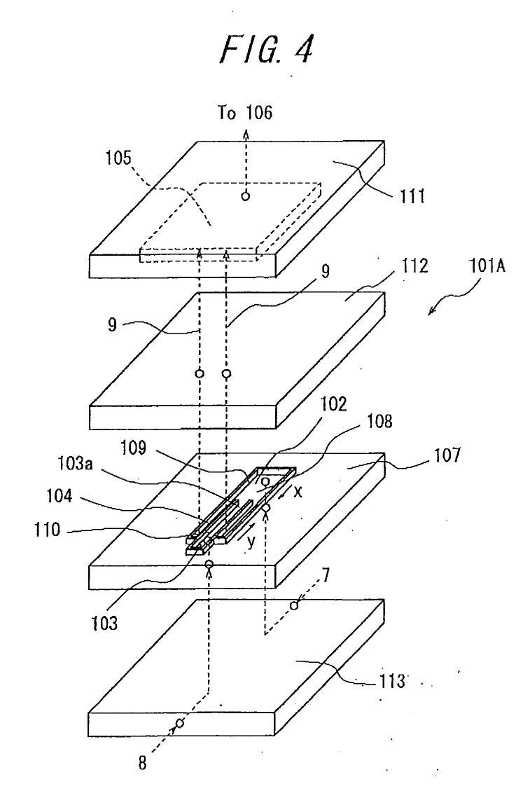

FIG. 4 is an exploded perspective view illustrating main components of a micro mixer of the second embodiment according to the first invention.

The illustrated micro mixer 101A of the second embodiment comprises a first defined groove 102 as a first guide flow passage, a second defined groove 103 as a second guide flow passage, a third defined grooves 104 as a third guide flow passage, a mixing-promoting space 105, and a guide member 106 as a fourth guide flow passage, and is constructed by a laminated body consisting of at least two plate-shaped members, or in the embodiment as shown in FIG. 4 four plate-shaped members 107, 111,112 and 113.

The first defined groove 102 is provided for guiding a first fluid 7 so as to be directed in a first direction x and is formed on the first plate-shaped member 107 to be bounded or defined by one bottom wall 108 and first groove walls 109. The first defined groove 102 is substantially rectangular when viewed in a plan view.

As shown in FIG. 5, the second defined groove 103 has a leading groove 103a defined and formed by second groove walls 110 in the downstream portion of the first defined groove 102. The leading groove 103a guides a second fluid 8 so that the second fluid 8 flows in a direction y opposite to the direction x. The leading groove 103a has a flow passage space S2 narrower than a flow passage space S1 of the downstream portion of the first defined groove 102.

The third defined groove 104 is defined by the downstream portion of the first defined groove 102 and the leading groove 103a of the second defined groove 103. The third defined grooves 104 serves to guide the mixed fluid 9 obtained by the counter-current collision of the first fluid 7 flowing in the first defined groove 102 and the second fluid 8 flowing in the second defined groove 103 so that the mixed fluid 9 is directed in the same direction as the first direction x, and the third defined grooves 104 further serves to increase the pressure of the mixed fluid 9.

The mixing-promoting space 105 is communicated with the third defined grooves 104 to lower the fluid pressure of the mixed fluid 9 discharged from the third defined grooves 104 and to promote the mixing of the mixed fluid 9 by vortexes produced in connection with the pressure drop of the mixed fluid. In other words, the mixing-promoting space 105 is a pressure-relieving space formed in the second plate-shaped member 111 overlapped together with said first plate-shaped member 107 at a location enabling the mixed fluid 9 discharged from the third defined grooves 104 of said first plate-shaped member 107 to flow into the mixing-promoting space 105. FIG. 4 illustrates the mixing-promoting space 105 in the configuration of the second plate-shaped member 111 overlapping with the first plate-shaped member 107 through a separate plate-shaped member 112. However, the second plate-shaped member 111 may be overlapped directly on the first plate-shaped member 107 or may be overlapped through two or more plate-shaped members 112, or in addition to the two or more plate-shaped members 112, one or more plate-shaped members 113 may be overlapped on the lower surface of the first plate-shaped member 107, the plate-shaped member 113 being formed with through-holes for conducting the first and second fluids into the first plate-shaped member 107. Such configurations may be suitably selected as needed.

The guide member 106 is provided to guide the mixed fluid flowing out of said second plate-shaped member 111 to a predetermined collecting means.

And the micro mixer of said second embodiment can also effectively improve the fluid mixing efficiency even in comparatively simple construction by employing the mechanism similar to that of the micro mixer of the first embodiment.

Moreover, as materials of the respective members constituting the micro mixers of the first and second embodiments, it is preferable to use, for example, alloys such as stainless steel or nickel based alloy, plastic resins such as Teflon and acrylics, glasses such as quartz, ceramics such as zirconia and silicon nitride, and the like. However, it is particularly preferable to use the alloys such as stainless steel or nickel based alloy from a point of view of preventing the members from being damaged due to pressure.

Further, a micro mixer according to the second invention comprises a first guide flow passage having a first guide portion which guides a first fluid to be directed in a first direction and a second guide portion connected to said first guide portion with an enlarged region of the second guide portion; a second guide flow passage provided concentrically to the first guide flow passage and having in the second guide portion of the first guide flow passage a discharge portion for guiding a second fluid to be directed in a direction opposite to said first direction, said discharge portion having a flow passage space narrower than the flow passage space of the second guide portion of the first guide flow passage, the discharge portion preferably positioned at the center of the first guide flow passage; a third guide flow passage defined by the second guide portion of the first guide flow passage and the discharge portion of the second guide flow passage, the third guide flow passage for guiding a mixed fluid caused by counter-flow collision of the first fluid flowing in the first guide flow passage and the second fluid flowing in the second guide flow passage to be directed in the direction the same as said first direction and for increasing the pressure of the mixed fluid; a mixing-promoting space communicating with said third guide flow passage for lowering the fluid pressure of the mixed fluid discharged from said third guide flow passage to promote mixing of the mixed fluid with the aid of vortexes caused in connection with the pressure drop; and a fourth guide flow passage for guiding the mixed fluid in said mixing-promoting space into a predetermined collecting means.

The embodiment according to the second invention will now be described with reference to drawings hereinafter.

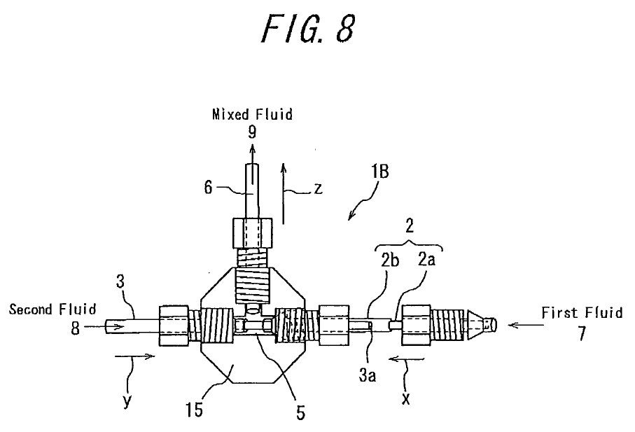

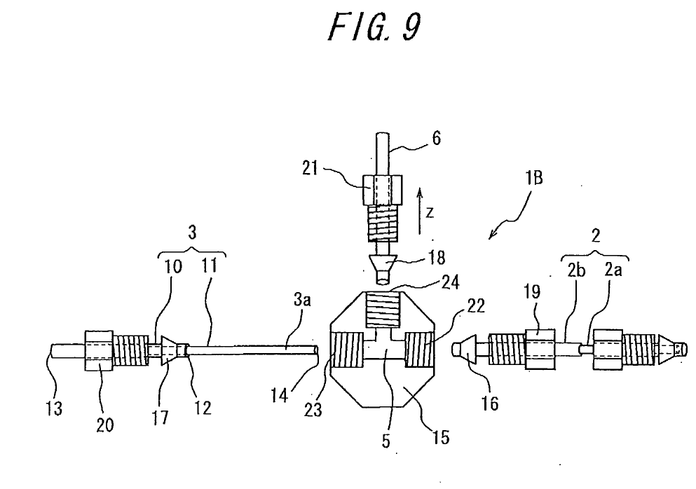

FIGS. 8 and 9 illustrate the main components of the micro mixer of the third embodiment according to the second invention in a front elevation and an exploded view, respectively.

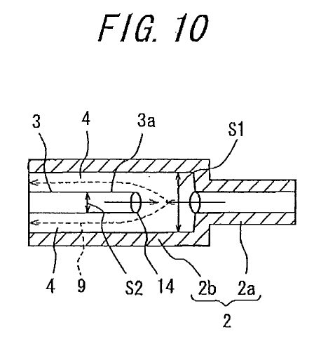

The micro mixer 1B of the third embodiment shown in FIGS. 8 and 9 comprises a first tubular member 2 as a first guide flow passage, a second tubular member 3 as a second guide flow passage, a first annular space 4 as a third guide flow passage (FIG. 10), a mixing-promoting space 5, and a third tubular member 6 as a fourth guide flow passage. The micro mixer 1B is constructed by connecting at least three tubular members, or three tubular members 2, 3 and 6 as shown in FIG. 9 preferably into a T-shape.

The first tubular member 2 is preferably straight, and although the first tubular member 2 in the first embodiment has the same diameter over its full length, the first tubular member 2 in the third embodiment is constructed by connecting a thin tube 2a as a first guide portion and a thick tube as a second guide portion corresponding to the downstream portion 2b of the first tubular member as shown in FIG. 8 for guiding a first fluid 7 to be directed in a first direction x.

The second tubular member 3 is preferably straight and has a tubular leading end 3a positioned in the thick tube of the first tubular member 2. The tubular leading end 3a is a discharge portion for guiding a second fluid 8 to be directed in a direction opposite to said first direction x, preferably in a direction making an angle 150° to 180° relative to the first direction x, most preferably in a direction y which is 180° opposite to the first direction x as shown in FIG. 8. The tubular leading end 3a has a flow passage space S2 narrower than the flow passage space S1 of the thick tube of the first tubular member 2. The second tubular member 3 is of a double tube structure consisting of an outer tube 10 having the same size as that of the thick tube of the first tubular member and an inner tube 11 having one end inserted in the outer tube 10 and the other end inserted in the first tubular member 2, and further the connection portion 12 of said outer tube 10 and the inner tube 11 is sealed in a watertight manner as shown in FIG. 9. However, the second tubular member 3 may be constructed only by one tube having the same diameter over its full length.

The first annular space 4 is defined by the thick tube 2b of the first tubular member 2 and the tubular leading end 3a of the second tubular member 3 and serves to guide a mixed fluid 9 caused by colliding the first fluid 7 flowing in the first tubular member 2 with the second fluid 8 flowing in the second tubular member 3 to be directed in the same direction as said first direction x, preferably in a direction making an angle of 0°-30° relative to the first direction x, the most preferably in a direction making an angle of 0° relative to the first direction x as shown in FIG. 8, and further serves to increase the pressure of the mixed fluid 9. As means for increasing the pressure of the mixed fluid 9 in the first annular space 4, for example, FIGS. 8 and 9 illustrate that the cross-sectional area of the flow passage of the first annular space 4 is narrowed in such a manner that the outer diameter of the tubular leading end 3a of the second tubular member 3 is enlarged as close to the inner diameter of the thick tube 2b of the first tubular member 2 as possible. The pressure of the mixed fluid 9 may be increased by increasing the flow rate of the first fluid 7 or the second fluid 8. In order to pressurize the mixed fluid 9, various configurations may be contemplated.

The mixing-promoting space 5 is a pressure-relieving space formed in a block-shaped number 15 positioned between the inlet 13 and the outlet 14 of the second tubular member 3 and is communicated with the first annular space 4 so that the fluid pressure of the mixed fluid 9 discharged from the annular space 4 is lowered and mixing of the mixed fluid 9 is promoted with the aid of vortexes caused in connection with the pressure drop of the mixed fluid 9.

The third tubular member 6 is provided to guide the mixed fluid 9 in the mixing-promoting space 5 into a predetermined collecting means (not shown). The third tubular member 6 is mounted on the block-shaped member 15 so that the mixing fluid 9 flowing in the annular space 4 is directed in a direction z deflected by an angle of 90° relative to the direction x in FIG. 8.

FIG. 10 is a schematic view for illustrating the flow of the mixed fluid 9 caused by colliding the first fluid 7 flowing in the first tubular member 2 with the second fluid 8 flowing in the second tubular member 3 in a counter-flow manner.

In the micro mixer 1B according to the invention, as shown in FIG. 10, the first fluid 7 and the second fluid 8 are supplied in a counter-flow manner at the position of the outlet 14 of the second tubular member 3 for discharging the second fluid 8 or at an immediately downstream position of the outlet 14 so that the two fluids are mixed with each other by collision to obtain the mixed fluid 9. In the case that the mixed fluid 9 is difficult to form a completely mixed state, for example, a mixed fluid consisting of water as a first fluid and a 10% solution of polyacrylic acid as a second fluid, however, a completely mixed fluid could not be obtained by mixing the two fluids of low flow rates (or low velocities) such as, for example, 0.1 ml/min or less by using a micro mixer of the prior art.

Then, said mixed fluid 9 is pressurized in the first annular space 4 defined by the thick tube 2b of the first tubular member 2 and the tubular leading end 3a of the second tubular member 3, and thereafter the mixed fluid 9 is discharged into the mixing-promoting space 5. At this time, the mixed fluid 9 passing through the first annular space 4 flows in the same direction as the flowing direction of the first fluid 7 (direction x) and opposite to the flowing direction of the second fluid 8 (direction y).

Similarly to the first embodiment, according to the third embodiment mixing and agitating of the mixed fluid 9 discharged from the first annular space 4 into the mixing-promoting space 5 is further promoted by vortexes caused when the fluid pressure of the mixed fluid 9 pressurized in the first annular space 4 is relieved in the mixing-promoting space 5. Therefore, according to the third embodiment of the invention the mixing efficiency of the fluids can be effectively enhanced even in a micro mixer of comparatively simple construction.

In the third embodiment, moreover, a ratio among cross-sectional areas of the thin tube 2a of the first tubular member 2, the tubular leading end 3a of the second tubular member 3, and the first annular space 4 are preferably 0.1-5:1:1-3. Further, the distance from the tip of the thin tube 2a of the first tubular member 2 to the distal end of the tubular leading end 3a of the second tubular member 3 is preferably 0.001 mm to 5 mm, more preferably 0.01 mm to 1 mm, and furthermore preferably 0.05 mm to 0.1 mm. The construction employing these values is preferable because it contributes to the effects for increasing the kinetic energy of the two fluids associated with the mixing caused by collision, for decreasing diffusion distances of molecules associated with the mixing caused by contracted flows, and for effectively forming the vortexes associated with the mixing caused by the pressure increase and the pressure relieve (pressure drop) of the mixed fluid.

The second fluid 8 discharged from the second tubular member 3 is preferably larger in fluid flux than the first fluid 7 flowing in the first tubular member 2. For example, in the case that the first fluid 7 is 2% solution of sulfuric acid and the second fluid 8 is 10% solution of sodium hydroxide, it is preferable that the difference in fluid flux between the second fluid 8 and the first fluid 7 is 20 mm/s or more.

Moreover, the fluid pressure P1 of the mixed fluid 9 flowing in the first annular space 4 is preferably 0.2 to 5 MPa, and the fluid pressure P2 of the mixed fluid 9 flowing in the mixing-promoting space 5 is preferably 0.1 to 1 MPa. The pressure difference (P1−P2) is preferably 0.1 to 5 MPa, more preferably 0.5 to 1 MPa. Further, the mixed ratio of the first and second fluids may be adjusted by, for example, suitably setting the flow rates of pumps for supplying the first and second fluids, respectively.

In order to prevent said fluids from flowing in reverse directions, moreover, the first and second tubular members 2 and 3 may be provided with check valves (not shown), if desired.

In the micro mixer of the third embodiment as shown in FIG. 9, further, the first, second and third tubular members 2, 3 and 6 are provided with sealing members 16, 17 and 18 for keeping the water-tightness, respectively, and connection portions or male screws of bolts 19, 20 and 21 provided on the first, second and third tubular members 2, 3 and 6 are screw-connected to threaded portions (female screws) 22, 23 and 24 provided in the block-shaped member 15 forming the first annular space, respectively. However, the invention is not to be limited to such an embodiment. The material for said sealing members 16, 17 and 18 is not limited to a particular material so long as the material can maintain the water-tightness, and such materials include, for example, metals such as aluminum, alloys such as stainless steel or nickel based alloy, plastic resins such as Teflon (registered trade name), and the like.

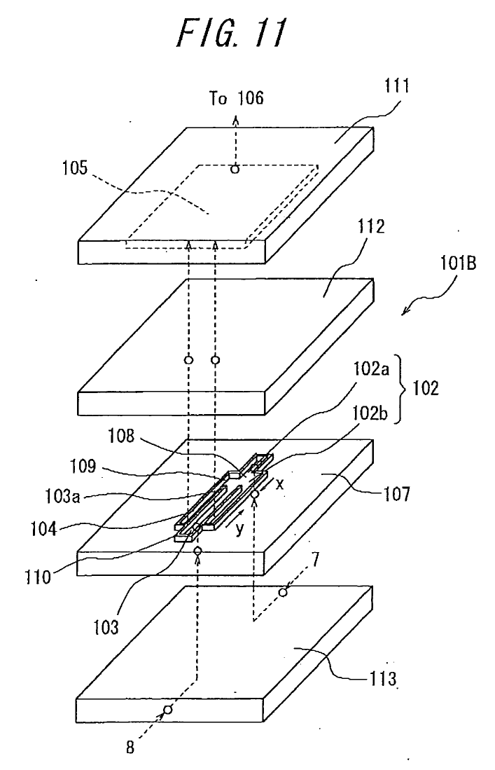

FIG. 11 is an exploded perspective view illustrating main components of a micro mixer of the fourth embodiment according to the second invention.

The micro mixer 101B of the fourth embodiment mainly comprises a first defined groove 102 as a first guide flow passage, a second defined groove 103 as a second guide flow passage, a third defined grooves 104 as a third guide flow passage, a mixing-promoting space 105, and a guide member 106 as a fourth guide flow passage, and is constructed by a laminated body consisting of at least two plate-shaped members, or in the embodiment as shown in FIG. 11 four plate-shaped members 107, 111, 112, 113.

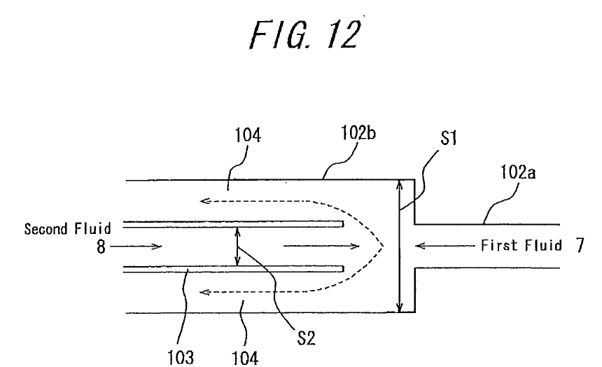

The first defined groove 102 is provided to guide a first fluid 7 so as to be directed in a first direction x and is formed on the first plate-shaped member 107 to be bounded or defined by one bottom wall 108 and first groove walls 109. In FIG. 12, the first defined groove 102 is constructed by connecting a thin groove portion 102a as the first guide portion and a thick groove portion 102b as the second guide portion.

The second defined groove 103 has a leading groove 103a defined and formed by second groove walls 110 in the thick groove portion 102b of the first defined groove 102. The leading groove 103a guides a second fluid 8 to be directed in a direction y opposite to said first direction x and has a flow passage space S2 narrower than the flow passage space S1 of the thick groove portion 102b of the first defined groove 102.

The third defined grooves 104 is defined by the thick groove portion 102b of the first defined groove 102 and the leading groove 103a of the second defined groove 103 and serves to guide the mixed fluid 9 caused by colliding the first fluid 7 flowing in the first defined groove 102 with the second fluid 8 flowing in the second defined groove 103 in a counter-flow manner so that the mixed fluid 9 is directed in the same direction as said first direction x and at the same time the pressure of the mixed fluid 9 is increased.

The mixing-promoting space 105 is communicated with the third defined grooves 104 to lower the fluid pressure of the mixed fluid 9 discharged from the third defined grooves 104 so that the mixing of the mixed fluid 9 is promoted by vortexes caused in connection with the pressure drop of the mixed fluid. For this purpose, the mixing-promoting space 105 is a pressure-relieving space formed in the second plate-shaped member 111 overlapped together with said first plate-shaped member 107 at a location enabling the mixed fluid 9 discharged from the third defined grooves 104 of said first plate-shaped member 107 to flow into the mixing-promoting space 105. FIG. 11 illustrates the mixing-promoting space 105 formed by overlapping the second plate-shaped member 111 on the first plate-shaped member 107 through a separate plate-shaped member 112. However, the second plate-shaped member 111 may be overlapped directly on the first plate-shaped member 107 or may be overlapped through two or more plate-shaped members 112, or in addition to the two or more plate-shaped members 112, one or more plate-shaped members 113 may be overlapped on the lower surface of the first plate-shaped member 107, the plate-shaped member 113 being formed with through-holes for conducting the first and second fluids into the first plate-shaped member 107. Such configurations may be suitably selected as needed.

The guide member 106 is provided to guide the mixed fluid flowing out of said second plate-shaped member 111 into a predetermined collecting means.

And the micro mixer according to the second invention can also effectively improve mixing efficiency of fluids even in a comparatively simple construction of the micro mixer by employing the mechanism similar to that of the micro mixer according to the first invention.

As materials of the respective members constituting the micro mixers of the third and fourth embodiments, moreover, it is preferable to use, for example, alloys such as stainless steel or nickel based alloy, plastic resins such as Teflon and acrylics, glasses such as quartz, ceramics such as zirconia and silicon nitride, and the like. However, it is particularly preferable to use the alloys such as stainless steel or nickel based alloy from a point of view of preventing the members from being damaged due to pressure.

While the invention has been particularly shown and described with reference to examples of embodiments of the invention, it will be understood by those skilled in the art that any modifications and changes can be made within the scope of the appended claims of the invention.

### EXAMPLE

Micro mixers of two kinds according to the invention were experimentally manufactured, and fluids of two kinds were mixed using the micro mixers. The results thereof will be explained hereinafter.

### Example 1

A micro mixer of the first embodiment according to the first invention comprised three tubular members as shown in FIG. 1, that is, a first tubular member 2 (35 mm length, 1.6 mm outer diameter, and 0.48 mm inner diameter), a second tubular member 3 (outer tube 10 having 35 mm length, 1.6 mm outer diameter, and 0.48 mm inner diameter, and inner tube 11 having 10 mm length, 0.44 mm outer diameter, and 0.14 mm inner diameter), and a third tubular member 6 (50 mm length, 1.6 mm outer diameter, and 0.48 mm inner diameter). Used as a first fluid 7 was 2% sulfuric acid solution, and used as a second fluid was a solution consisting of four solutions, obtained by mixing 1.60% KI solution, 0.41% KIO₃ solution, 3.34% H₃BO₃ solution, and 0.80% NaOH solution at a rate of 1:1:1:1 by volume. The third tubular member 6 is provided with an ultraviolet-visible spectral photometer so that the mixed solutions directly flow into the spectral photometer. A flow rate of the first fluid 7 flowing in the first tubular member 2 was 0.125 to 0.5 ml/min, and a flow rate of the second fluid 8 flowing in the second tubular member 3 was 0.125 to 0.5 ml/min. Ratio of the first fluid 7 and the second fluid 8 constituting the mixed fluid 9 flowing in the third tubular member 6 was 1:1. A flow rate of the mixed fluid 9 flowing in the third tubular member 6 was varied within a range of 0.25 to 1.0 ml/min.

### Example 2

A micro mixer of the third embodiment according to the second invention comprised three tubular members as shown in FIG. 8, that is, a first tubular member 2 (thin tube 2a having 10 mm length, 1.5 mm outer diameter, and 0.14 mm inner diameter, and thick tube 2b having 35 mm length, 1.6 mm outer diameter, and 0.48 mm inner diameter), a second tubular member 3 (outer tube 10 having 35 mm length, 1.6 mm outer diameter, and 0.48 mm inner diameter, and inner tube 11 having 48.9 mm length, 0.44 mm outer diameter, and 0.14 mm inner diameter), and a third tubular member 6 (50 mm length, 1.6 mm outer diameter, and 0.48 mm inner diameter). Used as a first fluid 7 was 2% sulfuric acid solution, and used as a second fluid was a solution consisting of four solutions, obtained by mixing 1.60% KI solution, 0.41% KIO₃ solution, 3.34% H₃BO₃ solution, and 0.80% NaOH solution at a rate of 1:1:1:1 by volume. The third tubular member 6 is provided with an ultraviolet-visible spectral photometer so that the mixed solutions directly flow into the spectral photometer. A flow rate of the first fluid 7 flowing in the first tubular member 2 was 0.125 to 0.5 ml/min, and a flow rate of the second fluid 8 flowing in the second tubular member 3 was 0.125 to 0.5 ml/min. A ratio of the first fluid 7 and the second fluid 8 constituting the mixed fluid 9 flowing in the third tubular member 6 was 1:1. A flow rate of the mixed fluid 9 flowing in the third tubular member 6 was varied within a range of 0.25 to 1.0 ml/min.

### Comparative Examples 1 and 2

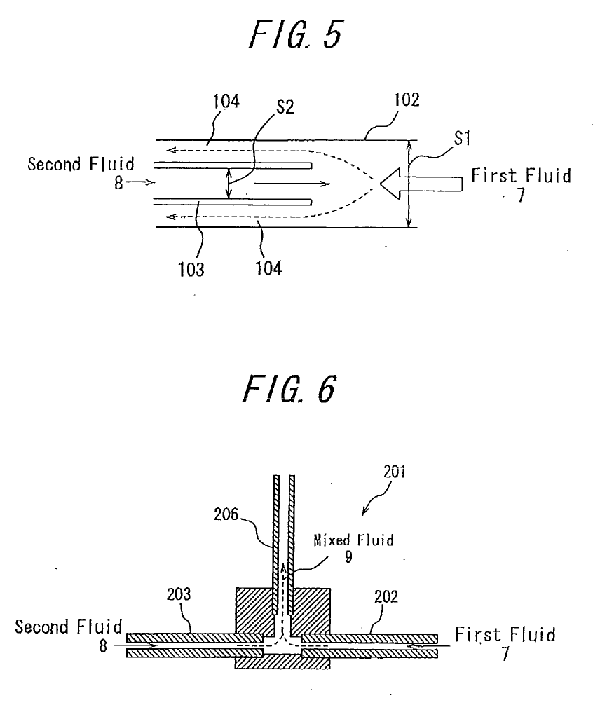

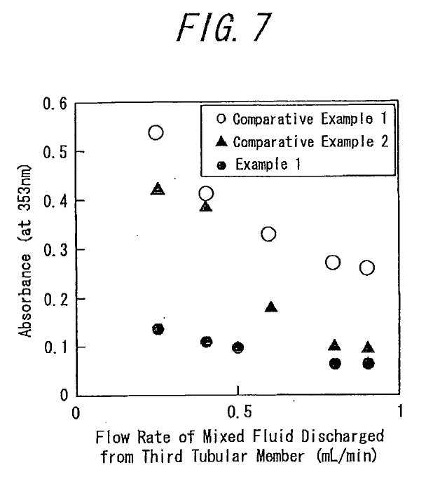

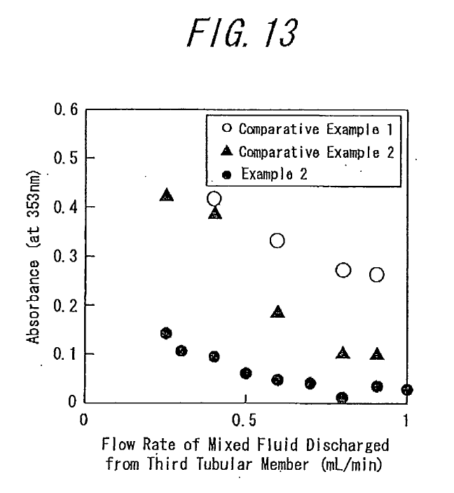

As shown in FIG. 6, for comparison, a micro mixer 201 was experimentally manufactured, which was similar to the micro mixers in Examples 1 and 2 in the feature of providing a first tubular member 202 and a second tubular member 203 in opposition to each other so that a first fluid 7 flowing in the first tubular member 202 and a second fluid 8 flowing in the second tubular member 203 are caused to counter-currently collide against each other to obtain a mixed fluid 9, but was different in the feature of causing the mixed fluid 9 to be discharged directly through a third tubular member 206 without being flowed through a first annular space and a mixing-promoting space. Using the micro mixer 201, mixing characteristics were estimated, results of which are shown in FIG. 7. In the experiments for obtaining the results of the Comparative Example 1 shown in FIGS. 7 and 13, used were the first and second tubular members 202 and 203 having lengths of 35 mm, outer diameters of 1.6 mm, and inner diameters of 0.48 mm, and the third tubular member 206 having a length of 50 mm, an outer diameter of 1.6 mm, and an inner diameter of 0.48 mm. In the Comparative Example 2, the first and second tubular members 202 and 203 have lengths of 35 mm, outer diameters of 1.6 mm, and inner diameters of 0.14 mm, and the third tubular member 206 has a length of 50 mm, an outer diameter of 1.6 mm, and an inner diameter of 0.48 mm.

Mixing characteristics of the mixed fluids of the first and second fluids were evaluated using the Villermaux/Dushman reactions. In more detail, utilizing the phenomenon that when two kinds of fluids are being mixed, fast reactions preferentially progress in the case of excellent mixing characteristics, but slow reactions simultaneously progress in the case of inferior mixing characteristics, the mixing characteristics can be evaluated by measuring concentrations of substances produced in the slow reactions. In particular, when the first fluid and the second fluid are mixed, the neutralization reaction of acid and alkali occurs or I2 formation reaction occurs which is a reaction when the mixing characteristics is inferior. When the I2 formation reaction occurs, part of the produced I2 changes into I3, which has an absorption peak at the wavelength of 353 nm. Therefore, the mixing characteristic was evaluated depending upon the measured absorbance. In the Examples, it is clearly shown that the smaller the absorption intensity (absorbance) at the wavelength of 353 nm, the better is the mixing characteristic. Evaluation results are shown in FIGS. 7 and 13.

As can be seen in the results in FIGS. 7 and 13, the absorption intensities at the wavelength of 353 nm by means of the micro mixers of Examples 1 and 2 are smaller at any flow rates than those by means of the micro mixers of Comparative Examples 1 and 2 so that the mixing characteristics of the micro mixers according to the invention are superior to those of the micro mixers of the prior art.

### INDUSTRIAL APPLICABILITY

According to the invention, it becomes possible to provide the micro mixer, which is capable of effectively enhancing the mixing efficiency even in a small and simple construction. According to the invention, particularly, it is possible to increase mixing efficiency of the mixed fluid caused by colliding a first fluid flowing in a first guide flow passage with a second fluid flowing in a second guide flow passage in a counter-flow manner. Moreover, the mixed fluid obtained by collision is guided so as to be directed in the same direction as said first direction in a third guide flow passages to form vortexes, while further the pressure of the mixed fluid is increased by narrowing the flow passage to shorten a diffusion distances of molecules as much as possible, thereby further enhancing the mixing efficiency. Furthermore, the mixed fluid discharged from the third guide flow passage is caused to flow into the mixing-promoting space so as to lower the fluid pressure to produce vortexes so that mixing of the mixed fluid is promoted by the vortexes caused by the fluid pressure drop. In this way, according to the invention, a complete mixing can be readily obtained, even if first and second fluids are difficult to form a complete mixed state and even with low flow rates (low velocities) of fluids.

1. A micro mixer comprising:
a first guide flow passage for guiding a first fluid to be directed in a first direction,
a second guide flow passage having a discharge portion in the downstream portion of said first guide flow passage for guiding a second fluid to be directed in a direction opposite to said first direction, said discharge portion having a flow passage space narrower than the flow passage space of the downstream portion of said first guide flow passage,
a third guide flow passage defined by the downstream portion of said first guide flow passage and the discharge portion of said second guide flow passage for guiding a mixed fluid caused by colliding the first fluid flowing in the first guide flow passage with the second fluid flowing in the second guide flow passage in a counter-flow manner to be directed in the same direction as said first direction and for increasing the pressure of said mixed fluid,
a mixing-promoting space communicating with said third guide flow passage for lowering the pressure of the mixed fluid discharged from said third guide flow passage to promote mixing of the mixed fluid with the aid of vortexes caused in connection with the pressure drop of the mixed fluid, and
a fourth guide flow passage for guiding the mixed fluid in said mixing-promoting space into a predetermined collecting means.

2. The micro mixer as claimed in claim 1, wherein the first to fourth guide flow passages are formed by connecting at least three tubular members, and
wherein the first guide flow passage is formed by the first tubular member,
the second guide flow passage is formed by the second tubular member having a tubular leading end inserted in the downstream portion of said first tubular member,
the third guide flow passage is a first annular space defined by the downstream portion of said first tubular member and the tubular leading end of said second tubular member,
the mixing-promoting space is a pressure-relieving space formed in a block-shaped member positioned between the inlet and the outlet of the second guide flow passage, and
the fourth guide flow passage is formed by the third tubular member.

3. The micro mixer as claimed in claim 1, comprising a laminated body of at least two plate-shaped members, and
wherein the first guide flow passage is a first defined groove defined and formed by a bottom wall and first groove walls on the first plate-shaped member and is substantially two-dimensionally rectangular,
the second guide flow passage is a second defined groove having a leading groove defined and formed by second groove walls in the downstream portion of said first defined groove on said first plate-shaped member,
the third guide flow passage is a third defined grooves defined by the downstream portion of said first defined groove and the leading groove of said second defined groove,
the mixing-promoting space is a pressure-relieving space formed in the second plate-shaped member overlapped together with said first plate-shaped member at a location enabling the mixed fluid discharged from the third defined groove of said first plate-shaped member to flow into the mixing-promoting space, and
the fourth guide flow passage is formed by a guide member for guiding the mixed fluid flowing out of said second plate-shaped member into predetermined collecting means.

4. A micro mixer comprising:
a first guide flow passage having a first guide portion for guiding a first fluid to be directed in a first direction and a second guide portion connected to said first guide portion with an enlarged size of the second guide portion,
a second guide flow passage having in the second guide portion of said first guide flow passage a discharge portion for guiding a second fluid to be directed in a direction opposite to said first direction, said discharge portion having a flow passage space narrower than the flow passage space of the second guide portion of the first guide flow passage,
a third guide flow passage defined by the second guide portion of the first guide flow passage and the discharge portion of the second guide flow passage for guiding a mixed fluid caused by colliding the first fluid flowing in the first guide flow passage with the second fluid flowing in the second guide flow passage in a counter-flow manner to be directed in the same direction as said first direction and further for increasing the pressure of said mixed fluid,
a mixing-promoting space communicating with said third guide flow passage for lowering the fluid pressure of the mixed fluid discharged from said third guide flow passage to promote the mixing of the mixed fluid with the aid of vortexes caused in connection with the pressure drop of the mixed fluid, and
a fourth guide flow passage for guiding the mixed fluid in said mixing-promoting space into predetermined collecting means.

5. The micro mixer as claimed in claim 4, wherein the first to fourth guide flow passages are formed by connecting at least three tubular members, and
wherein the first guide flow passage is formed by the first tubular member constructed by connecting a thin tube as the first guide portion and a thick tube as the second guide portion,
the second guide flow passage is formed by the second tubular member having a tubular leading end inserted in the thick tube of said first tubular member,
the third guide flow passage is a first annular space defined by the thick tube of said first tubular member and the tubular leading end of said second tubular member,
the mixing-promoting space is a pressure-relieving space formed in a block-shaped member positioned between the inlet and the outlet of the second guide flow passage, and
the fourth guide flow passage is formed by a third tubular member.

6. The micro mixer as claimed in claim 1, comprising a laminated body of at least two plate-shaped members, and
wherein the first guide flow passage is a first defined groove defined and formed by a bottom wall and first groove walls on the first plate-shaped member and constructed by connecting a thin groove portion as a first guide portion and a thick groove portion as a second guide portion,
the second guide flow passage is a second defined groove having a leading groove defined and formed by second groove walls in the thick groove portion of said first defined groove on said first plate-shaped member,
the third guide flow passage is a third defined grooves defined by the thick groove portion of said first defined groove and the leading groove of said second defined groove,
the mixing-promoting space is a pressure-relieving space formed in the second plate-shaped member overlapped together with said first plate-shaped member at a location enabling the mixed fluid discharged from the third defined grooves of said first plate-shaped member to flow into the mixing-promoting space, and
the fourth guide flow passage is formed by a guide member for guiding the mixed fluid flowing out of said second plate-shaped member into predetermined collection means.
